(19) United States
(12) Patent Application Publication
(10) Pub. No.: US 2015/0356214 A1
(43) Pub. Date: Dec. 10, 2015

(54) OPERATION METHOD AND APPARATUS FOR PERFORMING LITHOGRAPHY-RELATED SIMULATION, AND RECORDING MEDIUM

(71) Applicant: CANON KABUSHIKI KAISHA, Tokyo (JP)

(72) Inventor: Tadashi Arai, Saitama-shi (JP)

(21) Appl. No.: 14/733,586

(22) Filed: Jun. 8, 2015

(30) Foreign Application Priority Data
Jun. 10, 2014 (JP) 2014-120001

(51) Int. Cl. G06F 17/50; G06F 17/14

(52) U.S. Cl. CPC G06F 17/5009; G06F 17/14

(57) ABSTRACT

A sub processing unit, which is easy in design and versatile, is used to perform a lithography-related simulation at high speed. An operation method for performing a lithography-related simulation for forming a pattern on a substrate by using a processor includes sharing the lithography-related simulations with a central processing unit and a Many Integrated Core. Among the lithography-related simulations, the Many Integrated Core performs a parallel operation related to data of a spatial domain.

### BACKGROUND

1. Field of the Invention

The present disclosure relates to an operation method and an operation apparatus for performing a lithography-related simulation, and a recording medium.

2. Description of the Related Art

The manufacturing process of a semiconductor device, a liquid crystal display apparatus, etc. includes a lithography process for forming a pattern on a substrate. The lithography process uses, for example, an exposure apparatus for illuminating a mask via an illumination optical system, and projecting an image of a pattern of the mask onto a photosensitive resist on the substrate via a projection optical system. In recent years, the progress in pattern miniaturization makes it more difficult to form a pattern on a substrate with high precision. Accordingly, various techniques for improving the pattern resolution, for example, modified illumination by using an illumination optical system for illuminating a mask, and optical proximity correction (OPC) on a mask pattern are used. A simulation is performed in advance by using these techniques to check an image formed on a substrate and to optimize exposure conditions and various parameters for masking.

As an example of a tool for performing such a simulation, a simulator employing the Sum of Coherent Sources (SOCS) method is offered from Mentor-Graphics. This simulator utilizes the SOCS method for algorithm not only to achieve higher speed calculation but also to support parallel operations of a central processing unit (CPU), enabling calculations on the entire device chip (several tens square millimeters).

U.S. Unexamined Patent Application Publication No. 2005/0097500 specification discusses a technique for performing a lithography-related simulation by using not only a central processing unit (CPU) as hardware but also an application-specific integrated circuit (ASIC) and a field-programmable gate array (FPGA) as a sub processing unit in order to perform further high speed calculation. The ASIC and FPGA are exclusively designed according to operation details of a simulation to be executed, and are capable of high-speed parallel operations, achieving higher calculation speed in comparison with the CPU.

U.S. Unexamined Patent Application Publication No. 2006/0242618 specification discusses a technique for performing a simulation by using a graphics processing unit (GPU) as a sub processing unit. The GPU can be configured at lower cost than the CPU, ASIC, and FPGA. The GPU is a processor for performing parallel operations for image processing by using exclusive hardware.

However, when the ASIC or FPGA is used, it is necessary to exclusively design a device according to operation details of a simulation to be executed, resulting in an increased number of design processes and a prolonged design period. Since the ASIC and FPGA are exclusively designed to be optimized for exclusive operations for a simulation to be executed, the operation speed will decrease when used in operations other than exclusive operations. Likewise, when the GPU is used, it is necessary to perform exclusive coding for the GPU, resulting in an increased number of design processes and a prolonged design period. Further, there is a problem that the GPU cannot achieve a target operation speed in complicated operations such as an “if” statement. Therefore, a sub processing unit having higher operation speed and more versatility is demanded.

### SUMMARY

As disclosed herein, an operation method for performing a lithography-related simulation for forming a pattern on a substrate by using a processor includes sharing the lithography-related simulations with a central processing unit and a Many Integrated Core. Among the lithography-related simulations, the Many Integrated Core performs a parallel operation related to data of a spatial domain.

Further features of the present invention will become apparent from the following description of exemplary embodiments with reference to the attached drawings.

### BRIEF DESCRIPTION OF THE DRAWINGS

FIG. 1 illustrates a configuration of an operation apparatus.

FIG. 2 is a flowchart illustrating an operation method according to a first exemplary embodiment.

FIG. 3 illustrates a pattern divided into a plurality of regions.

### DESCRIPTION OF THE EMBODIMENTS

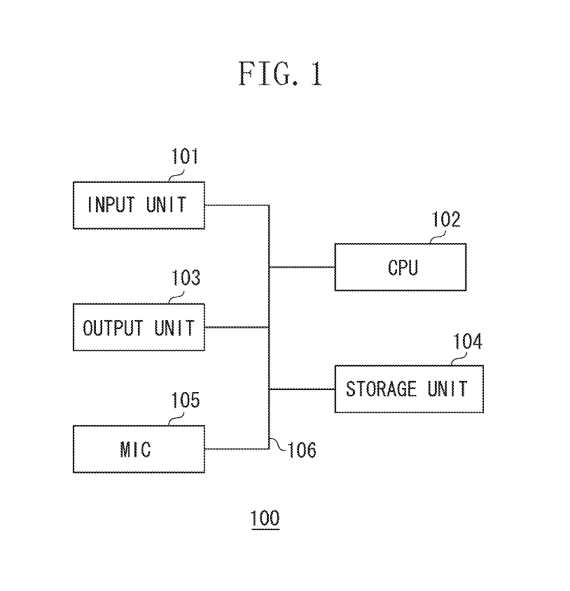

FIG. 1 illustrates a configuration of an operation apparatus for performing a lithography-related simulation. An operation apparatus 100 includes an input unit 101 such as a keyboard and a mouse, a central processing unit 102, an output unit 103 such as a display and a recording apparatus, a storage unit 104 such as a memory, and a Many Integrated Core (MIC) 105 as a sub processing unit. These units are electrically connected by a bus (wiring) 106.

The central processing unit 102 is a processor which bears main functions in the operation apparatus 100, controls each unit, and performs operation processing. The central processing unit 102 reads and executes a program stored in the storage unit 104, and transmits and receives data to/from the input unit 101, the output unit 103, the storage unit 104, and the MIC 105 connected via the bus 106. The central processing unit 102 is referred to as a central processing unit (CPU) or a micro processing unit (MPU) implemented in a microchip. However, the central processing unit 102 can also be configured as a digital signal processor (DSP) specialized for signal processing in arithmetic operations.

A MIC 105 is a processor which assists the central processing unit 102 (the heart of the operation apparatus 100), and performs various types of operation and processing. The MIC 105 includes many cores serving as processing units, and is capable of performing a high-speed parallel operation with many cores. Since the MIC 105 implements the x86 instruction set, many cores can be controlled by using a program for the x86 series. Therefore, depending on cases, existing codes and development tools are usable, and existing codes are executable without changing at all. For this reason, the MIC 105 is easier in design and more versatile than the ASIC, FPGA, and GPU which are designed to be optimized for exclusive operations in a simulation to be executed. Among lithography-related simulations, the MIC 105 is particularly suitable for parallel operations on data of the 1-, 2-, or 3-dimensional spatial domain, and is capable of performing relevant parallel operations at high speed. Data of the spatial domain refers to data having information about each position in a space. Examples of data of the spatial domain include bitmap data in which the light intensity at each position in the 2-dimensional space is represented by bits, and data of 2-dimensional pattern shapes.

The storage unit 104 may have a memory for storing files of various parameters. Although the input unit 101 and the output unit 103 are provided as different units in FIG. 1, these units may be configured as a same single unit.

An operation method for performing a lithography-related simulation will be described below. Lithography refers to forming a pattern on a substrate by using a lithography apparatus. Lithography apparatuses includes, for example, an exposure apparatus for illuminating a mask and projecting an image of a pattern of the mask using a projection optical system, a near-field exposure apparatus, an electron beam exposure apparatus for exposing a substrate by using an electron beam, and an imprint apparatus for transferring a pattern of a mold to a substrate. Exemplary embodiments of a lithography-related simulation will be described below.

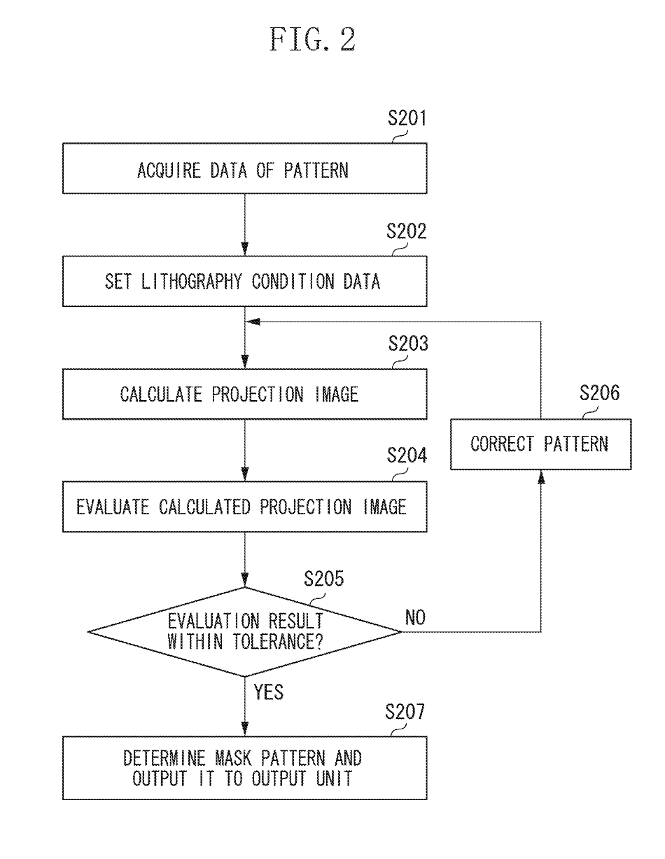

A first exemplary embodiment will be described below. As a lithography-related simulation, an operation method according to the present exemplary embodiment performs optical proximity correction on a pattern of a mask used in a projection exposure apparatus. FIG. 2 is a flowchart illustrating an operation method according to the first exemplary embodiment. The operation apparatus 100 performs each process of the relevant operation method.

In step S201, the operation apparatus 100 acquires data of a pattern designed as a pattern for a mask. Data of a pattern is provided as graphic data in the Graphic Database System II (GDSII) or Open Artwork System Interchange Standard (OASIS) format, and is input, for example, from the input unit 101 by a user. The operation apparatus 100 stores the acquired data of the pattern in the storage unit 104. In step S202, the operation apparatus 100 sets data of lithography conditions. Lithography conditions include, for example, exposure conditions used by the exposure apparatus, and conditions of a photosensitive agent (resist) on the substrate. Exposure conditions include, for example, exposure wavelength, numerical aperture (NA) of a projection optical system, aberration, illumination conditions for illuminating a mask, and defocusing. Resist conditions includes, for example, the amount of convolution for a resist model.

In step S203, by using the set data of lithography conditions, the operation apparatus 100 calculates a projection image to be formed on the image plane of the projection optical system by illuminating the relevant pattern under set illumination conditions when the pattern acquired in step S201 is arranged on an object plane of the projection optical system. Projection image calculation methods include calculations using an optical model based on the Abbe's image forming theory, and calculations using the Transmission Cross Coefficient (TCC). A projection image is a 2-dimensional image which appears when the light intensity distribution of a mask pattern image is sliced with a predetermined light intensity value. A mask pattern image is formed on the image plane side of the projection optical system when the illumination optical system illuminates a mask. A projection image is data of the spatial domain and is represented by bitmap or a 1-dimensional array expressing the 2-dimensional image with a set of points. Therefore, in calculation of a projection image related to data of the spatial domain, the MIC 105 and the central processing unit 102 share operations. The MIC 105 mainly bears operation portions in which higher operation speed is achievable through operation parallelization. The central processing unit 102 bears processing for controlling the MIC 105, operation portions that are not performed by the MIC 105, and operation portions which cannot be parallelized.

In particular, the MIC 105 performs operations related to data of a pattern which is data of the spatial domain or data of the light intensity distribution on a predetermined plane. Operations performed by the MIC 105 include a parallel operation for converting polygon data of a pattern into bitmap data in gray scale, and a parallel operation for generating bitmap data of the effective light source distribution (the light intensity distribution on the pupil plane of the illumination optical system for illuminating the surface to be illuminated). Operations performed by the MIC 105 further include a parallel operation for performing the Fourier transform processing on bitmap data, a parallel operation for generating bitmap data of a pupil filter indicating the pupil of the projection optical system, and a parallel operation for performing the inverse Fourier transform on the pupil function in consideration of the pupil filter. Operations performed by the MIC 105 further include a parallel operation for illuminating the mask with each light source on the pupil plane of the illumination optical system, and adding the light intensity distribution formed by the projection optical system for all of the light sources. In a parallel operation for generating bitmap data of the effective light source distribution, for example, in the case of circular illumination, the operation apparatus 100 sets light intensity of 1 to point light source elements within a range of radius of 0.5 or less, and sets light intensity of 0 to point light source elements within a range of radius exceeding 0.5, assuming that the maximum radius of the pupil plane of the illumination optical system is 1. In a parallel operation for generating bitmap data of the pupil filter, the operation apparatus 100 defines the aberration, birefringence, pupil transmittance distribution or pupil transmittance difference between polarized light by setting coefficient values for the Zernike polynomial for each point of the pupil.

In step S204, the operation apparatus 100 evaluates the projection image calculated in step S203. In projection image evaluation, the operation apparatus 100 sets an evaluation point to be subjected to projection image evaluation, and calculates an evaluation index by using data of the projection image at the relevant evaluation point. The evaluation index includes, for example, “line width (CD)”, “shift amount”, “intensity log slope (ILS)”, and “depth of focus”. In projection image evaluation related to data of the spatial domain, the MIC 105 and the central processing unit 102 share operations. The MIC 105 mainly bears operation portions in which higher operation speed is achievable through operation parallelization. The central processing unit 102 bears processing for controlling the MIC 105, operation portions that are not performed by the MIC 105, and operation portions which cannot be parallelized.

Parallel operations performed by the MIC 105 include, for example, operations for the line width of the projection image on the image plane, the shift amount of the projection image on the image plane, and the normalized image log-slope (NILS) in the light intensity distribution of the projection image for each evaluation position. The MIC 105 is also able to acquire the depth of focus by calculating the line width of the projection image on a plane defocused from the best focus plane, and to acquire the exposure margin by calculating the line width of the projection image while changing the exposure amount.

In step S205, the operation apparatus 100 determines whether the projection image evaluation result acquired in step S204 is within a tolerance (allowable range). When the relevant evaluation result is determined to be not within the tolerance (NO in step S205), then in step S206, the operation apparatus 100 changes the parameters (position, size, and shape of the pattern) acquired in step S201 to correct the pattern. In this correction which is referred to as optical proximity correction, the operation apparatus 100 changes the size and position of pattern elements based on a projection image evaluation value such that the relevant evaluation value falls within the tolerance. After the correction, the operation apparatus 100 performs the following processes on the pattern. In step S203, the operation apparatus 100 calculates a projection image. In step S204, the operation apparatus 100 evaluates the projection image. In step S205, the operation apparatus 100 performs the determination process. The operation apparatus 100 repeats these processes until the evaluation result is determined to be within the tolerance in the determination process in step S205. Since the amount of operation processing performed in step S205 is not large, the relevant operation processing may be performed by either or both of the central processing unit 102 and the MIC 105.

When the operation apparatus 100 determines that the projection image evaluation result is within the tolerance (YES in step S205), it determines the relevant pattern as a pattern of the mask. In step S207, the operation apparatus 100 transmits the relevant pattern and the evaluation result to the output unit 103, for example, to display them on a display, and stores the evaluation result in the storage unit 104.

Although, in the above-described calculation and evaluation of a projection image, the central processing unit 102 and the MIC 105 share operations, the processing is not limited thereto. Another processing unit, for example, the FPGA, may be used in addition to the MIC 105 and the central processing unit 102.

It is determined that whether higher operation speed is achievable through operation parallelization by the MIC 105 in comparison with the conventional ASIC and FPGA. The MIC 105 may perform operation in which higher operation speed is determined to be achievable. Further, the MIC 105 may perform operations which are easier in design by the MIC 105 rather than by the conventional ASIC and FPGA.

As described above, a lithography-related simulation can be performed at high speed if the MIC 105, which is easy in design and versatile, performs parallel operation related to data of the spatial domain.

A second exemplary embodiment will be described below. An example of a parallel operation method according to the present exemplary embodiment is performed by the MIC 105. The method according to the present exemplary embodiment divides data of a pattern designed for a mask into a plurality of regions, and assigns one region to each of a plurality of cores configuring the MIC 105 such that the cores perform operation of mutually different regions. Then, each core of the MIC 105 performs calculation of a projection image of a pattern or evaluation of an optical image in the assigned calculation region.

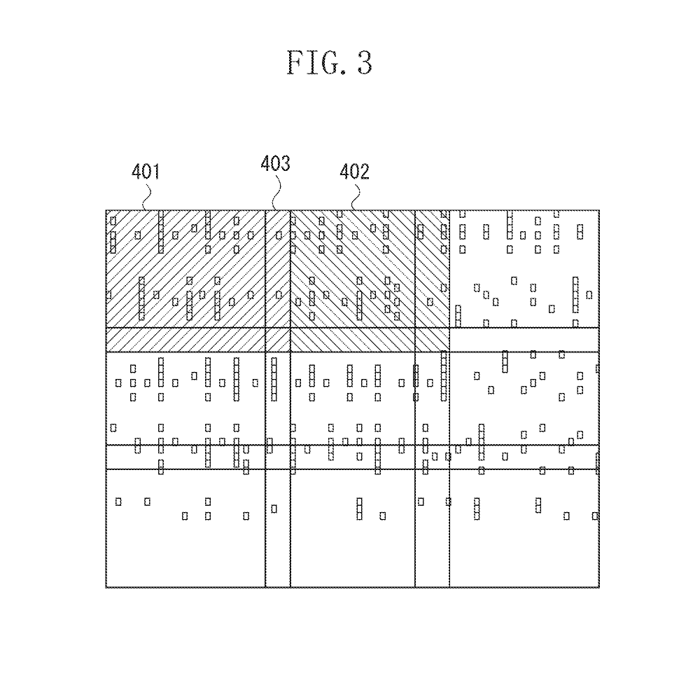

FIG. 3 illustrates a pattern divided into a plurality of regions. For example, the entire pattern is divided into 9 rectangular regions drawn by solid lines: a first region 401, a second region 402, and a plurality of other regions. Since a target projection image evaluation result cannot be obtained in the vicinity of each region boundary because of the optical proximity effect, the range of each region is extended to provide a margin. Therefore, respective regions overlap with each other in an overlap region 403.

A first core of the MIC 105 performs calculation and evaluation of a projection image in the first region 401 of the pattern. A second core of the MIC 105 different from the first core performs calculation and evaluation of a projection image in the second region 402 different from the first region 401. The MIC 105 is able to perform calculation and evaluation of projection images of the pattern through a parallel operation in this way. Although, in the overlap region 403, both the first and the second cores perform calculation of a projection image, either one of duplicated optical image evaluation results may be deleted later.

Further, a third core different from the first and the second cores of the MIC 105 may perform calculation and evaluation of projection images in the first region 401 and the second region 402.

### (Other Exemplary Embodiment)

Although, in the first exemplary embodiment, the MIC 105 performs calculation and evaluation of a projection image, the processing performed by the MIC 105 is not limited thereto. The MIC 105 is also able to perform operation processing only for calculation of a projection image. The MIC 105 is further able to acquire data of a projection image calculated by an external apparatus, and perform operation processing only for evaluation of the relevant projection image. Further, the MIC 105 is able to perform operations for calculation and evaluation of a latent image pattern on a resist formed by projecting an image on the resist on a substrate, a development pattern formed by developing the latent image pattern by using a developing solution, or an etching pattern formed by etching the development pattern as a mask. Further, the MIC 105 is applicable not only to calculation and evaluation of a pattern formed by a projection exposure apparatus but also to calculation and evaluation of a pattern on a substrate formed by an electron beam exposure apparatus and to calculation and evaluation of a pattern formed by transferring a pattern of a mold onto a substrate by a nanoimprint apparatus.

A concept discussed in the present exemplary embodiment can be mathematically modeled. Therefore, the present exemplary embodiment can be implemented as software functions of a computer system. Software functions of the computer system include programming having executable software codes. In the present exemplary embodiment, software functions execute partial coherent imaging calculations. Software codes are executed by a processor of the computer system. During operation of software codes, codes and related data are stored in a computer platform. However, software codes may be stored in other locations, or may be loaded into a suitable computer system. Therefore, software codes can be stored in at least one computer-readable recording medium as one or a plurality of modules. The present exemplary embodiment can be described in a format of the above-described codes, and can be operated as one or a plurality of software products.

### (Device Manufacturing Method)

A method for manufacturing a device (a semiconductor integrated circuit (IC) element, a liquid crystal display element, etc.) by using an exposure apparatus will be described below. A device is manufactured by using the above-described exposure apparatus through a process of exposing a substrate (a wafer, a glass substrate, etc.) with a resist applied thereon to a pattern, a process of developing the substrate (resist), and other known processes. Other known processes include etching, resist removing, dicing, bonding, packaging, and so on. When a nanoimprint apparatus is used, a device is manufactured through a process of pressing a pattern of a mold and a transfer material on a substrate, a process of hardening the transfer material, a process of transferring the pattern of the mold onto the transfer material, and the above-described other known processes including a process of performing etching by using the transferred pattern as a mask. According to the present device manufacturing method, a device having a higher quality can be manufactured in comparison with the conventional method.

While the present invention have specifically been described based on the above-described preferred exemplary embodiments, it is needless to say that the present invention is not limited thereto but can be modified in diverse ways within the ambit of the appended claims.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-120001, filed Jun. 10, 2014, which is hereby incorporated by reference herein in its entirety.

What is claimed is:

1. An operation method for performing a lithography-related simulation for forming a pattern on a substrate by using a processor, the method comprising sharing the lithography-related simulations with a central processing unit and a Many Integrated Core,
wherein, among the lithography-related simulations, the Many Integrated Core performs a parallel operation related to data of a spatial domain.

2. The operation method according to claim 1, wherein the parallel operations related to the data of the spatial domain include a parallel operation related to bitmap data and a parallel operation with a Fourier transform.

3. The operation method according to claim 1, wherein a first core of the Many Integrated Core performs an operation in a first region of the data of the spatial domain, and
wherein a second core different from the first core of the Many Integrated Core performs an operation in a second region different from the first region of the data of the spatial domain.

4. The operation method according to claim 3, wherein each core of the Many Integrated Core performs an operation in one region among a plurality of regions of the data of the spatial domain, and
wherein each core performs calculation of a different region.

5. The operation method according to claim 1, wherein the lithography-related simulation includes an operation related to an image or a pattern in a space.

6. The operation method according to claim 5, wherein operations related to an image or a pattern in the space include calculation or evaluation of a projection image of a pattern projected by a projection optical system, calculation or evaluation of a latent image formed by a resist on the substrate, or calculation or evaluation of a pattern formed on the substrate.

7. The operation method according to claim 1, wherein the Many Integrated Core performs:
a parallel operation for converting polygon data of a pattern into bitmap data;
a parallel operation for generating bitmap data of light intensity distribution on a pupil plane of an illumination optical system for illuminating a surface to be illuminated;
a parallel operation for generating bitmap data of a pupil filter on a pupil plane of a projection optical system for projecting an image of a pattern on a substrate;
a parallel operation for applying Fourier transform processing to bitmap data; or
a parallel operation for applying Fourier transform processing to a pupil function representing a pupil of the projection optical system.

8. The operation method according to claim 7, wherein the bitmap data of the pupil filter is represented by a Zernike polynomial.

9. The operation method according to claim 6, wherein, in the evaluation of the projection image, a value of an image width, an image shift amount, a NILS, an exposure margin, or a depth of focus at each evaluation point of the projection image is calculated.

10. The operation method according to claim 1, wherein lithography for forming a pattern on the substrate comprises:
forming a pattern on the substrate with an exposure apparatus for illuminating a mask and projecting a pattern of the mask on the substrate;
forming a pattern on the substrate with an electron beam exposure apparatus; or
forming a pattern on the substrate with an imprint apparatus.

11. A non-transitory recording medium storing a program for causing the central processing unit and the Many Integrated Core to execute the operation method according to claim 1.

12. An operation apparatus for performing a lithography-related simulation for forming a pattern on a substrate, the operation apparatus comprising:
a central processing unit; and
a Many Integrated Core,
wherein the central processing unit and the Many Integrated Core share the lithography-related simulations, and
wherein, among the lithography-related simulations, the Many Integrated Core performs a parallel operation related to data of a spatial domain.
